(19) United States
(12) Patent Application Publication
(10) Pub. No.: US 2006/0155523 A1
(43) Pub. Date: Jul. 13, 2006

(54) Method and device for representing a cell implemented in a partially depleted silison-on-insulator type CMOS technology

(75) Inventors: Vincent Liot, Grenoble (FR); Philippe Flatresse, Froges (FR)

Correspondence Address: ALLEN, DYER, DOPPELT, MILBRATH & GILCHRIST P.A., 1401 CITRUS CENTER 255 SOUTH ORANGE AVENUE, P.O. BOX 3791, ORLANDO, FL, 32802-3791, US

(73) Assignee: STMicroelectronics SA, Montrouge (FR)

(21) Appl. No.: 11/328,799

(22) Filed: Jan. 10, 2006

(30) Foreign Application Priority Data
Jan. 11, 2005 (FR) 05 00267

(51) Int. Cl. G06F 17/50

(52) U.S. Cl. 703/19

(57) ABSTRACT

A first simulation running through all the possible input states is used to collect information on the drain, gate and source biasing of each transistor. This transistor bias information is used to perform an interpolation in charts of internal potentials. These charts are tabulations of internal potentials for different drain, gate and source biases, different transistor widths and different power supply voltages. The values extracted from these charts can then be compared in order to obtain maximum and minimum internal potential values. These maximum and minimum internal potential values are then used to precondition the logic gate in a state that is an amalgamation of all the steady states that are the most favourable and/or least favourable in terms of propagation time and consumption.

### FIELD OF THE INVENTION

The invention relates to the behavior of CMOS logic circuits implemented in a partially depleted silicon-on-insulator type technology (PD-SIO), and, more particularly, in terms of time delay for these circuits, for example.

### BACKGROUND OF THE INVENTION

In recent years, the silicon-on-insulator (SOI) technology has proved to be a particularly interesting alternative to the conventional CMOS technology implemented on solid silicon. More particularly, the “floating substrate” effects, well known to those skilled in SOI technology, and the reduction of the junction capacitances are the main reasons for the enhanced performance provided by this SOI technology. However, the floating substrate effects present drawbacks.

One of these is the hysteresis effect of the threshold voltage of a transistor, which is reflected in time delay variations. That is, variations in the propagation time of a signal between the input and the output of a logic cell incorporating such transistors, such as an inverter.

A partially depleted silicon-on-insulator type technology introduces a “time” dependency of the delays such that the same structure can present different delays from one cycle to the next when it is timed by a clock signal. A method of initializing the voltage of the floating substrate is widely used in the design of the SOI circuits and error tolerances are used to take into account these time constraints. However, such a solution can lead to an over-estimation or under-estimation of the performance of the structure implemented.

Moreover, not only the delays in the worst case situations, but also the delays in the best case situations need to be known, in particular to take into account synchronization problems. However, both worst cases and best cases are difficult to identify because the process and design parameters such as current gain, input slope, charge, power supply and temperature play a key role. Also, the variable nature of the threshold voltages in the PD-SOI technologies is such that the propagation of a given transition between the input and the output of a logic cell leads to a different delay depending on whether DC steady state conditions apply or an AC steady state condition has been achieved.

In addition, it has proved difficult in practice to represent a logic cell by exhaustive simulations because several thousand cycles, and therefore several hours of simulation, are necessary to achieve the AC steady state, and this for simple inverter type cells. Moreover, the number of different DC states increases exponentially with the number of inputs. The representation of a much more complex cell is totally unthinkable by this method.

U.S. patent application Ser. No. 2003/0078763 proposes a comparison of charge states used to obtain maximum and minimum internal potential or “floating substrate potential” values for each transistor of a circuit to be represented. These internal potential values are then used in an electrical simulator in order to extract a fast transistor model abstraction and a slow transistor model abstraction. A simulator, capable of using the model abstractions, performs a simulation on the circuit to be represented by using a combination of these fast and slow models so as to obtain, for example, the worst or the best case for the propagation time inside the circuit.

Such a solution is particularly clumsy to implement because the method described in this prior patent application requires the use of a conventional electrical simulator capable of making use of the model abstractions or a conventional electrical simulator and a second simulator supporting the model abstractions. This entails developing, supporting and validating two different simulators.

Moreover, the method described in this prior patent can be used only at the cost of a rough approximation. In practice, the nodes of the drains and sources of the transistors are considered as being either at 0 volts or at the power supply voltage VDD. It is not possible in this document of the prior art to envisage different potentials for the transistor drains and sources. Moreover, only six different charge states of the internal potentials can be taken into account in calculating the maximum and minimum internal potential values.

### SUMMARY OF THE INVENTION

The invention may provide a more satisfactory solution to the problem of representing SOI-PD type CMOS cells. According to a first aspect, a method of representing a cell to be implemented in a partially depleted silicon-on-insulator type CMOS technology is proposed, and this cell may include a number of MOS transistors.

According to a general aspect, the method may comprise a preliminary phase, independent of the characteristics of the cell, in which a database is created, containing, for at least one reference transistor having the reference characteristics, different internal potential values of the floating substrate of the reference transistor. These different internal potential values may be obtained for one and the same reference bias of the electrodes of the reference transistor that may have been initially biased to different initial bias values.

This database having been created, the method may include a simulation in which the real biasing values of the electrodes of each transistor of the cell are determined for all the possible steady states of the cell (2ⁿ possible steady states for a logic cell with n inputs). The method may also include determining internal potential in which, for each transistor of the cell, a minimum value and a maximum value of its internal potential are determined from the different real biasing values and from the database, for example, by interpolation.

The method may also include an initialization phase in which the floating substrate of each transistor is initialized with the minimum and maximum values of its internal potential according to a set of predefined rules. Moreover, in this initialization phase, all the nodes of the cell may be initialized to the reference bias. That is, the reference biasing that was used to determine the internal potential of the reference transistors in the preliminary phase for creating the database.

Also, the method may include a representation phase in which a representation stimulus is applied to the duly initialized cell. In other words, an embodiment may be used to precondition a cell, for example a logic cell, by initializing the floating substrates of the transistors and of the internal input and output nodes of the circuit. This preconditioning may be used to amalgamate the different possible steady states of a cell to obtain in a single simulation the worst or the best case for the propagation time or the AC consumption, for example.

For this, a first simulation of the cell running through all the possible input states may be used to collect the information on the drain, gate and source bias of each transistor. Then, this transistor biasing information may be used to perform an interpolation in internal potential charts (database). These charts may be tabulations of internal potentials for different drain, gate and source biases, different transistor widths and different power supply voltages.

The extraction methodology used for generating the charts may be used to obtain internal potential values representative of the charge state of the transistor. The values extracted from these charts may then be compared to obtain maximum and minimum internal potential values. These maximum and minimum internal potential values may then be used to precondition the cell in a state that is an amalgamation of all the steady states that are most favorable and/or least favorable in terms of propagation time or consumption, for example.

Thus, the invention may divide by 2ⁿ⁻¹ the number of simulations needed to represent a logic gate with n inputs. Only one simulator may be needed to perform the method. Moreover, the method may be independent of the simulator used. In practice, any simulator that can be used to initialize the voltage of a node and extract a voltage value during a simulation may be sufficient to implement this method.

Moreover, according to an embodiment in which the internal potential determination may include an interpolation in the database, it may be possible to estimate very precisely (a few millivolts out of approximately 1 volt) the maximum and minimum internal potential values. The method may thus be used to encompass an infinity of charge states with the only imprecision being that of the interpolation in a two-dimensional table.

According to an embodiment, in the preliminary phase for creating the database, the electrodes of the reference transistor may be initially biased with different initial bias values, then, for each initial bias set, these initial bias values may be restored in a very short time or set time to the reference bias. This very short time may be in practice less than the discharge time of the floating substrate of the transistor, and it may be a few picoseconds, for example, 5 picoseconds.

In practice, according to a preferred embodiment, the database may be created for different reference transistors having different reference characteristics, for example, different channel widths, different power supply voltages, different operating temperatures, and different fabrication processes.

As an example, the set of predefined rules may include the following rule: When the propagation of a rising input edge on the gate of a transistor of the cell should be accelerated, or when the propagation of a falling input edge on the gate of this transistor should be delayed, the floating substrate of this transistor should be initialized to the corresponding maximum internal potential value. And, when the propagation of a rising input edge on the gate of a transistor of the cell should be delayed or when the propagation of a falling input edge on the gate of this transistor should be accelerated, the floating substrate of this transistor should be initialized to the corresponding minimum internal potential value.

Another typical rule may be as follows: The floating substrate of a transistor of the cell that switches and the gate of which is subject to no signal edge, and which is linked directly or indirectly by its source or its drain to another transistor of the cell, the gate of which is subject to a signal edge, is initialized to the corresponding maximum or minimum internal potential value depending on whether the floating substrate of this other transistor is initialized to the maximum or minimum value, respectively.

In other words, if the internal potential of the floating substrate of the other transistor is initialized with its maximum internal potential value, the floating substrate of the first transistor will also be initialized with the corresponding maximum internal potential value.

The CMOS cell to be represented may be a logic cell, for example, of logic gates with a number of inputs and one or more stages. The representation phase then may include, for example, determination of the best case and worst case of time propagation between an input signal of the cell and the corresponding output signal. In such a case, the set of predefined rules may include, for example, for the determination of the best propagation case, the initialization of the floating substrate of each transistor of the cell, the gate of which is subject to a rising edge, to the corresponding maximum internal potential value, and the initialization of the floating substrate of each transistor of the cell, the gate of which is subject to a falling edge, to the corresponding minimum internal potential value.

The set of predefined rules may include, for example, for the determination of the worst propagation case, the initialization of the floating substrate of each transistor of the cell, the gate of which is subject to a rising edge, to the corresponding minimum internal potential value, and the initialization of the floating substrate of each transistor of the cell, the gate of which is subject to a falling edge, to the corresponding maximum internal potential value.

The CMOS cell to be represented may also be a sequential cell, for example, a flip-flop. When the sequential cell includes an input for a clock signal and an input for a data signal, the representation phase may include, for example, a limiting of the time difference between the clock signal and the data signal.

According to another aspect, a system for representing a cell to be implemented in a partially depleted silicon-on-insulator type CMOS technology is proposed, and this cell may include a number of MOS transistors. A general characteristic of this system may comprise a memory storing a database containing, for at least one reference transistor having reference characteristics, different internal potential values of the floating substrate of the reference transistor obtained for a reference bias of the electrodes of the reference transistor initially biased to different initial bias values. The system may also comprise a simulation unit or simulation means for determining, for all the possible steady states of the cell, the real bias values of the electrodes of each transistor of the cell.

The system may further comprise an internal potential determiner or means of determining internal potential suitable for determining, for each transistor of the cell, a minimum value and a maximum value of its internal potential based on different real bias values and the database. The system may also comprise an initialization unit or characterization means suitable for initializing the floating substrate of each transistor with the minimum or maximum value of its internal potential according to a set of predefined rules, initializing all the nodes of the logic cell to the reference bias, and applying a characterization stimulus to the duly initialized cell.

According to an embodiment, the system may further include an auxiliary unit or auxiliary means suitable for creating the database by simulation based on a model of the reference transistor. The auxiliary unit or auxiliary means may preferably be suitable for initially biasing the electrodes of the reference transistor with different initial bias values, then, for each set of initial biases, restoring these initial biases in a very short time to said reference bias. The internal potential determiner or means of determining internal potential advantageously may include an interpolator or interpolation means suitable for performing an interpolation in the database, which can be created in practice for different reference transistors having different reference characteristics.

When the CMOS cell is a logic cell, the initialization unit or characterization means may be, for example, suitable for determining the best case and the worst case of time propagation between an input signal of the cell and the corresponding output signal. When the CMOS cell is a sequential cell, including, for example, an input for a clock signal and an input for a data signal, the initialization unit or characterization means are advantageously suitable for limiting the time difference between the clock signal and the data signal so as to ensure the functionality of the cell.

### BRIEF DESCRIPTION OF THE DRAWINGS

Other advantages and characteristics of the invention will become apparent on examining the detailed description of embodiments and implementations, by no means limiting, and the appended drawings in which:

FIG. 1 illustrates a prior art transistor implemented in a partially depleted silicon-on-insulator type technology;

FIG. 2 illustrates an embodiment of the method according to the invention;

FIG. 3 illustrates an exemplary embodiment of the preliminary phase for creating the database of FIG. 2;

FIG. 4 is an example of a logic cell to be characterized according to one embodiment of the invention;

FIG. 5 illustrates a phase for extracting the real potentials of the transistor electrodes of FIG. 4;

FIG. 6 illustrates an example of intermediate result obtained by an embodiment of the method according to the invention;

FIGS. 7 and 8 illustrate examples of predefined rules for obtaining a worst case and a best case of propagation according to the invention;

FIG. 9 illustrates a characterization phase of the method according to the invention;

FIG. 10 illustrates an example of simulation result obtained by an embodiment of the method according to the invention; and

FIGS. 11, 12a and 12b illustrate an example of sequential cell and of typical constraint of such a cell in accordance with the invention.

### DETAILED DESCRIPTION OF THE PREFERRED EMBODIMENTS

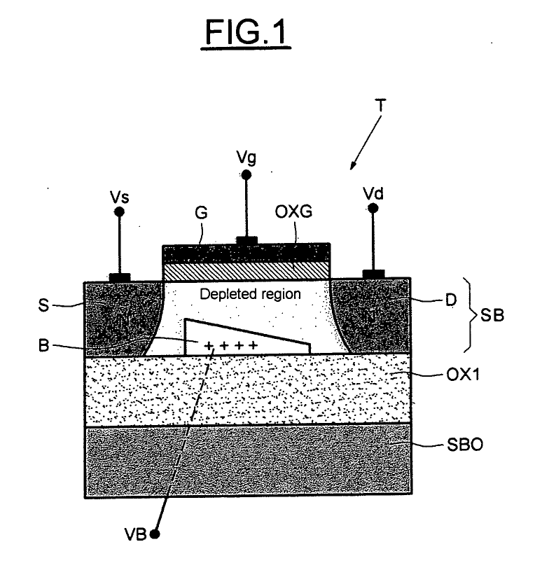

In FIG. 1, the reference T denotes an NMOS transistor implemented on a silicon substrate SB on an insulating layer OX1. This insulating layer OX1 is itself on a carrier substrate SBO. This structure is typical of a so-called SOI structure well known to those skilled in the art.

When the thickness of the oxide layer OX1 is sufficiently great, for example typically greater than 50 nanometres, the substrate SB is of the partially depleted type. In such a transistor, there is a neutral zone B located under the depleted region and between the source and drain regions. This neutral zone, which will accommodate holes, is not connected to a fixed potential. There is then said to be a “floating substrate” zone.

Naturally, besides this floating substrate zone, the transistor conventionally includes source, drain and gate zones, S, D and G respectively, the latter being insulated from the substrate SB via a gate oxide OG. The variations of the internal potential VB of the transistor T, that is, of the potential of the floating substrate BN, are caused in particular by the source/gate/drain capacitive coupling and by an ionization by impact, generation/recombination effects and gate tunnel effects.

These variations of internal potential lead in particular to variations in the threshold voltage and variations in the leakage and saturation currents of the transistor. Moreover, structures in partially depleted SOI technology present “history effects” which are reflected in particular in a time dependency of the delays. More specifically, the recent history of an input terminal has an impact on performance.

In any logic gate, each input vector imposes an original and unique combination of the biases of the transistors. Conditioning a circuit with an initial condition on the inputs and forced internal potentials therefore implies that these potentials have already been measured in this same circuit with an identical input vector. For example, in a gate with two inputs A and B, to obtain a charge state corresponding to the initial state A=0 and B=0 by initializing the gate to the state A=1 and B=0, it is necessary: to apply the initial condition A=0 and B=0 then rapidly restore the gate in transient state to the state A=1 and B=0 before measuring the internal potentials. These potentials can then be used to condition the gate in the state A=1 and B=0. The charge combination of the different transistors will then correspond to the initial condition A=0 and B=0 and not A=1 and B=0. It is then possible to apply all the possible initial condition vectors, measure the internal potentials after having transposed the gate to a reference input vector then compare the internal potentials deriving from the different initial conditions. The combination of internal potentials deriving from this comparison can then be processed by initializing the circuit with the reference input vector.

Two major objections oppose this methodology of conditioning the initial state. On the one hand, it is an extremely clumsy procedure, all the more so when a sequential gate contains one or more stored data items which act as additional initial conditions for determining the bias of certain transistors. In this case, it is not a state switchover that must be applied, but a quite exact input stimulus sequence to access the data, modify it and so transpose the gate to the reference state. On the other hand, a gate with die-stacking includes floating nodes, the value of which cannot be known accurately. In practice, they are subject to the influence of the internal potentials of the surrounding transistors. An uncertainty remains regarding the biasing of these transistors linked to the floating node. It differs according to the initial condition applied, including and above all, in the chosen reference input state.

The potentials of the transistors cannot therefore be compared then conditioned correctly with this method. Consequently, the internal potentials have to be left floating during initialization and the propagation times of the 2ⁿ different initial conditions vectors have to be tested. The method according to the invention, and in particular the unified conditioning procedure which will be explained in detail below, overcomes all these difficulties while considerably simplifying the internal potential measurement and initialization procedure.

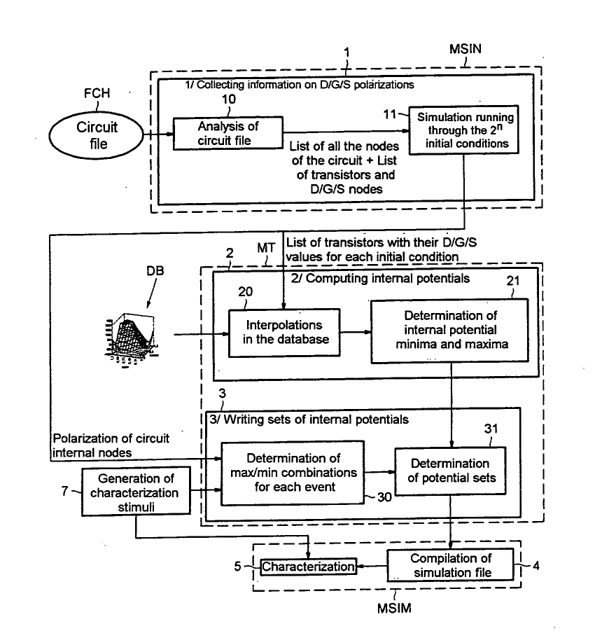

Reference is now made more particularly to FIG. 2 that describes an embodiment of the method according to the invention. From a net list file FCH describing the different nodes and components of the circuit to be represented, a phase 1 is applied for collecting information on the drain, gate and source biases of the different transistors of the circuit.

This collection primarily includes an analysis 10 of the file of the circuit so as to provide a list of all the nodes of the circuit and a list of the MOS transistors and of the drain/gate/source nodes. Then, a simulation 11 is performed in which, for the possible steady states of the cell (2ⁿ steady states for a cell with n inputs), the real bias values of the gate/drain/source electrodes of each transistor of the cell are determined.

Then, from the list of MOS transistors with their gate/drain/source potential values for each initial condition and from a database DB, which will be described in detail below, in a phase 2, the maximum and minimum values of the internal potentials of each transistor of the cell are determined. More specifically, phase 2 includes an interpolation in the database followed by a determination 21 of the internal potential minima and maxima.

Then, the sets of internal potentials are written 3 according to the parameters to be characterized. More specifically, phase 3 recovers the values of the internal nodes of the circuit (and not of the internal potentials of the transistors) to include them in the characterization stimuli files generated moreover in a manner known per se (step 7). The stimuli files describe all the possible events of a cell in the form of a succession of input states. Thus, by including the internal nodes in this description, it is possible to determine, for a given event, which transistor opens, which transistor closes and which transistor is not triggered (does not switch).

At this stage, behavioral rules of the history effect are applied, used to define, according to predefined rules, and for each event concerned, the combination of minimum and maximum internal potentials to be used for, for example, limiting the propagation time of the bundles of initial condition vectors (steps 30 and 31). At the end of phase 3, the sets of internal potentials determined in the step 31 are returned to a simulation file compilation tool 4. The next step is to characterize 5 the cell using this simulation file and the characterization stimuli.

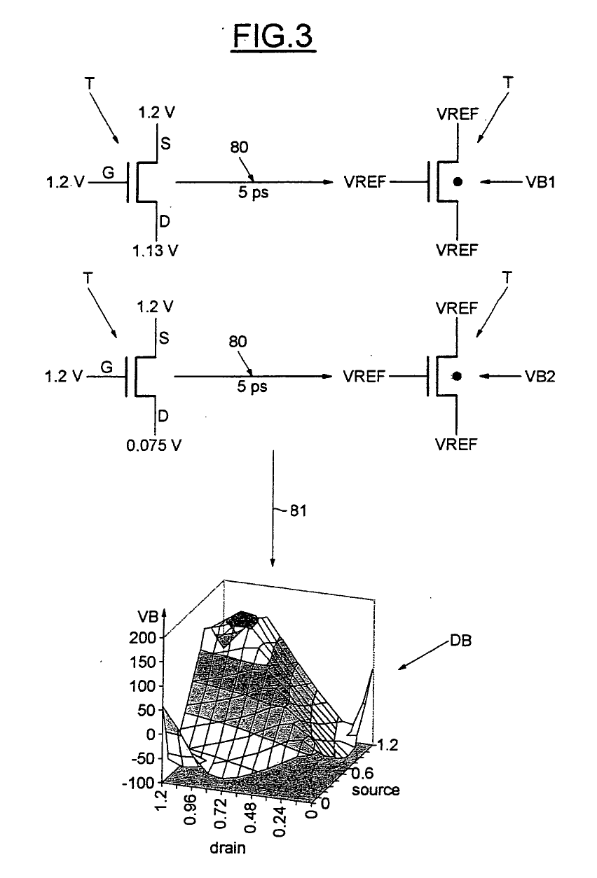

FIG. 3 illustrates in more detail a preliminary phase for creating the database DB. According to an embodiment, the internal potentials are extracted from the individual transistor or reference transistor. This is the reason why the preliminary phase in which the database is determined is independent of the cells to be characterized. In other words, internal potentials can be characterized before starting to characterize the cells of a library, and combined in the form of a database DB stored in a memory.

Moreover, as will be seen, the internal potentials are extracted in the same gate/drain/source bias state. The database is therefore applicable for any possible logic circuit topology. Such a database can be created immediately after extraction of the transistor models, for a fabrication process, and can be used to characterize any library of standard cells intended for the same fabrication process.

As illustrated in FIG. 3, the electrodes of the reference transistor T, or individual transistor, are initially biased with different initial bias values. Then, for each set of initial biases, these initial bias values are restored (step 80) in a very short time to a reference bias VREF, identical for all the electrodes of the transistor. This reference bias VREF is, for example, equal to 0 volts. The values VB1, VB2, etc. of the internal potential of the transistor are then determined for each initial bias set.

A chart of the database is then created (step 81) from all of these simulations for the individual reference transistor T. An example of chart of the database DB is illustrated at the bottom of FIG. 3 for, for example, an NMOS transistor having a gate raised to the power supply voltage VDD equal to 1.2 volts, at a temperature of 25° C. The charts provide the value of the internal potential VB according to initial bias values of the drain and the source.

In practice, the internal potentials are precharacterized for gate biases of 0 volts or VDD, which is commonly used in CMOS logic. However, the database contains a number of tables or charts relating to different gate widths and lengths, different combinations of power supply voltages, of dispersion of the fabrication process and of temperature. Some of these variables, like the power supply voltages, temperatures, fabrication process dispersions and transistor lengths are considered as discrete variables, which means that the possible values of these variables are known and limited in number.

Other variables, such as the drain and source biases and the widths of the transistors are considered to be continuous. They are not a priori known and can take any value within a known range.

Also, the invention advantageously provides for calculating their value by interpolation in the databases. Thus, the only imprecision in determining these values lies in the imprecision due to an interpolation in a two-dimensional table.

The database can thus be used to take account of the topology of the cells to a very precise and accurate degree, in particular with regard to the biases of the floating nodes in the stacking of the transistors.

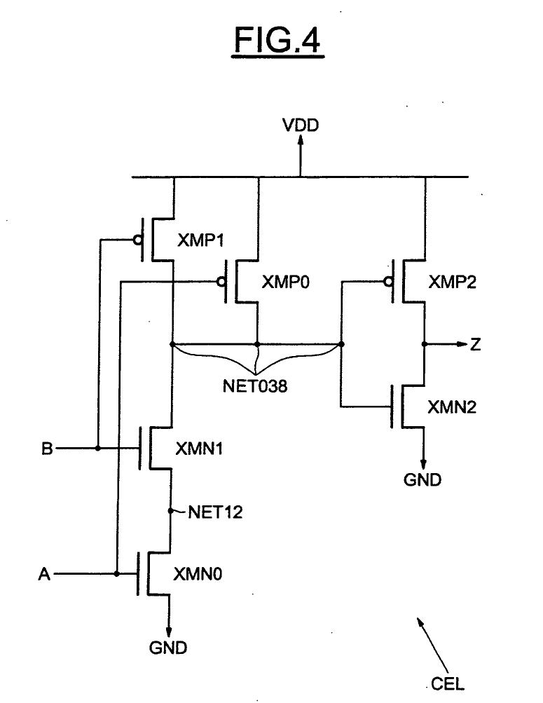

There now follows a description, referring more particularly to FIGS. 4 to 10, of an exemplary embodiment of the method according to the invention for characterizing a cell CEL, as illustrated in FIG. 4. This cell CEL is a logic cell. It is an AND logic gate with two inputs A and B and an output Z.

This logic cell CEL conventionally includes a first stage made up of NMOS transistors referenced XMN0 and XMN1 and PMOS transistors referenced XMP1 and XMP0. The gate of the transistor XMN0 and the gate of the transistor XMP0 are both linked to the input A of the cell whereas the gate of the transistor XMN1 and the gate of the transistor XMP1 are both linked to the input B of the cell.

The drains of the transistors XMP0 an XMP1 are linked together to the drains of the transistor XMN1 to form the internal node NET038. Moreover, the source of the transistor XMN1 is connected to the drain of the transistor XMN0 to form the node NET12.

The cell CEL includes a second stage made up of an inverter comprising an NMOS transistor referenced XMN2 and a PMOS transistor referenced XMP2. The gates of these two transistors are linked together to the node NET038 whereas the drain of the transistor XMP2 and the drain of the transistor XMN2 are linked together to form the output Z of the cell CEL.

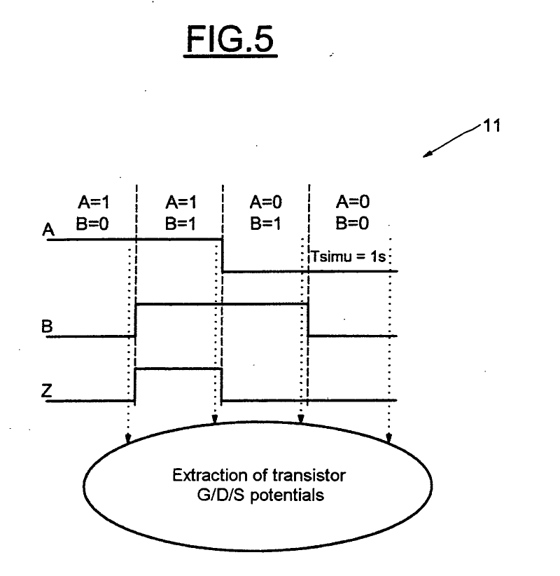

Before proceeding to extract the biases, the file FCH describing the topology of the cell at the transistor level will be read to list in particular the names of all the nodes linked to the drain/gate and source of the transistors of the cell. Then, the biases of the different transistors for all possible initial condition vectors will be collected (step 11, FIGS. 2 and 5). In the present case, when the cell is a two-input gate, there are four possible initial conditions illustrated in the top part of FIG. 5.

A simulation is then performed running through all the input states of the gate as shown in this FIG. 5. The input vectors are maintained for a time Tₛᵢₘᵤ sufficient to establish a steady state in the cell. In the present case, the simulation is performed for one second, for example. The potentials of all the nodes of the circuit are then extracted for each possible initial condition.

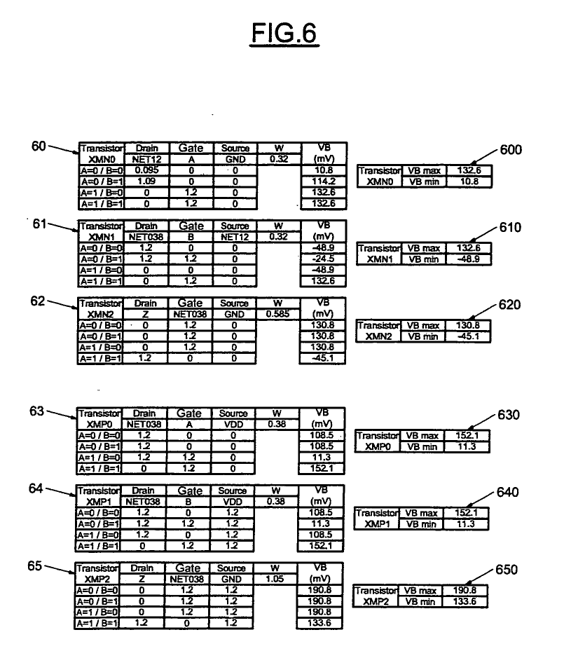

The values obtained are then linked to the different transistors of the circuit. Different values of the biases of the transistors for all the possible initial conditions are summarized in tables 60 to 65 of FIG. 6.

Then, given the widths W of the different transistors, the internal potentials VB of these different transistors are extracted from the database, possibly using an interpolation. The values of the internal potentials for each of the sets of real biases of the electrodes of the transistors are then obtained, as illustrated in the right-hand part of each of the tables 60 to 65.

The minimum value and the maximum value of the internal potential are then determined for each transistor. This is summarized in the tables 600, 610, 620, 630, 640 and 650 respectively associated with the different transistors of the cell. It should be noted here that all these internal potentials can be compared, because they were established in a unified manner for one and the same reference bias value VREF, for example the 0 volt value.

Then, the transistors will be initialized with the MIN or MAX values of their internal potentials according to a set of predefined rules and according to whether it is the worst or the best case of propagation for each event that is sought. More specifically, when, for example, the propagation of a rising input edge on the gate of a transistor of the cell needs to be accelerated, or when the propagation of a falling input edge on the gate of this transistor needs to be delayed, the floating substrate of this transistor is initialized to the corresponding maximum internal potential value.

However, when the propagation of a rising input edge on the gate of a transistor of the cell needs to be delayed, or when the propagation of a falling input edge on the gate of this transistor needs to be accelerated, the floating substrate of this transistor is initialized to the corresponding minimum internal potential value. More specifically, when it is the best case that is to be determined, a rule consists in initializing the floating substrate of each transistor of the cell, the gate of which is subject to a rising edge, to the corresponding maximum internal potential value, and in initializing the floating substrate of each transistor of the cell, the gate of which is subject to a falling edge, to the corresponding minimum internal potential value.

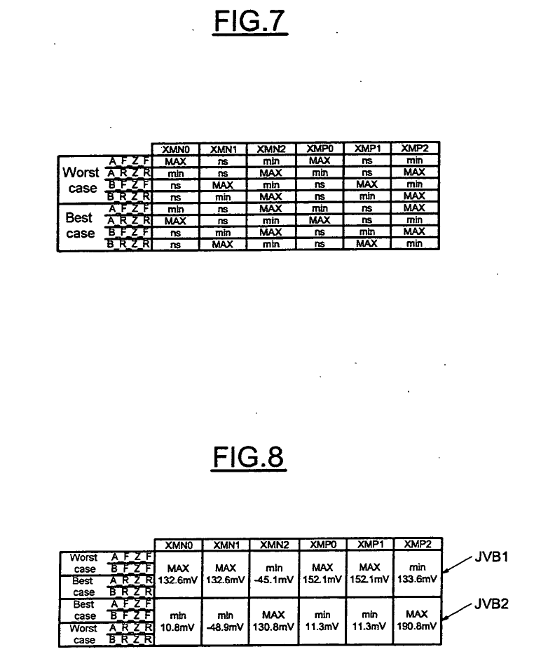

However, if it is the worst propagation case that is to be determined, a rule consists in initializing the floating substrate of each transistor of the cell, the gate of which is subject to a rising edge, to the corresponding minimum internal potential value, and in initializing the floating substrate of each transistor of the cell, the gate of which is subject to a falling edge, to the corresponding maximum internal potential value. This is illustrated for the example of the cell CEL, by the table of FIG. 7.

This table summarizes the MAX/MIN combinations of the different transistors for each event, and in this case there are four. The first event, referenced A_F_Z_F, signifies “A falls and Z falls”. The second event, referenced A_R_Z_R, signifies “A rises and Z rises”. The third event, referenced B_F_Z_F, signifies “B falls and Z falls”. Finally, the fourth event, referenced B_R_Z_R, signifies “B rises and Z rises”.

The recovery of the biasing of the internal nodes of the cell has, moreover, made it possible to determine for each event, which transistors do not trigger. These transistors are in this case assigned, in the table of FIG. 7, the reference ns alongside the event concerned.

Thus, for example, with respect to the transistor XMN0, and to obtain a worst propagation case in the case of the event A_F_Z_F, its internal potential will be initialized to its maximum value given that its gate is subject to a falling edge. The same applies for the transistor XMN1 with respect to the event B_F_Z_F. However, the floating substrates of these transistors will be initialized to their minimum internal potential value, for each of these two events, if it is the best propagation case that is of interest.

With respect to the transistor XMN2, and with respect to the event A_F_Z_F, the gate of the transistor XMN2 is subject to a rising edge. In practice, at the time of the falling edge applied to the gate of the transistor XMN0, the transistor XMP0 is conducting, provoking the application of a rising edge on the gate of the transistor XMN2. Consequently, since it is the worst propagation case that is of interest, the floating substrate of the transistor XMN2 should be initialized to its minimum internal potential value.

Two different sets of MAX/MIN combinations can then be defined in the table of FIG. 8 for initializing the floating substrates of the transistors of the cell. The first set JVB1, will be used to obtain the worst propagation case for the events A_F_Z_F and B_F_Z_F, and the best propagation case for the events A_R_Z_R and B_R_Z_R. The second set JVB2 will be used to obtain the complementary cases for these events.

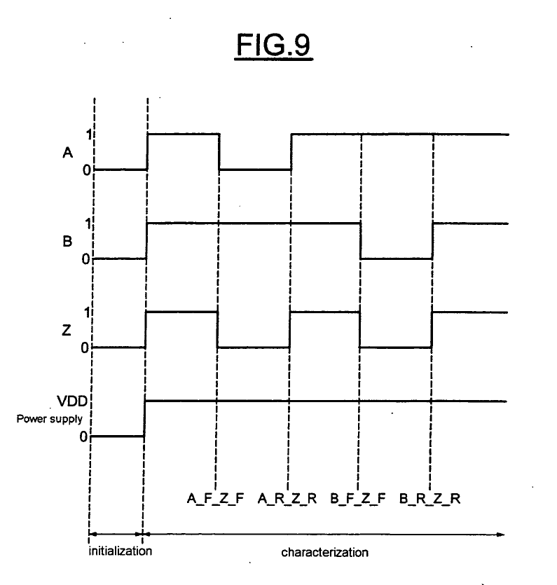

The next step, illustrated in FIG. 9, consists in characterizing the cell. For this, the floating substrate of each transistor is first of all initialized with its minimum or maximum internal potential value according to the set JVB1 or JVB2 used and all the nodes of the logic cell, that is, the inputs, outputs, any internal nodes of the cell and power supply nodes to which the drain, gate and source electrodes of the transistors are connected are initialized to the reference bias VREF, in this case 0 volts. This also includes initialization of the power supply node VDD to the reference value VREF.

Here, the conditioning of the cell is unified by the use of an identical bias VREF on all the nodes of the cell. Then, the simulation is run with the characterization stimulus used to obtain the four events concerned and described above. Also, as each of these events occurs, the propagation time Tp is determined.

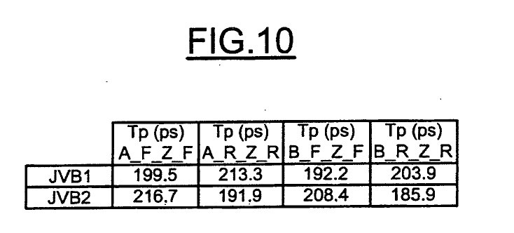

The results of these two simulations respectively performed with the two sets JVB1 and JVB2 are summarized in the table of FIG. 10. Thus, the propagation time Tp in picoseconds (ps) between a signal at one of the inputs of the cell and the signal at the output is obtained for each event, in the best propagation case and in the worst propagation case. Also, the invention makes it possible to obtain these results using only two simulations.

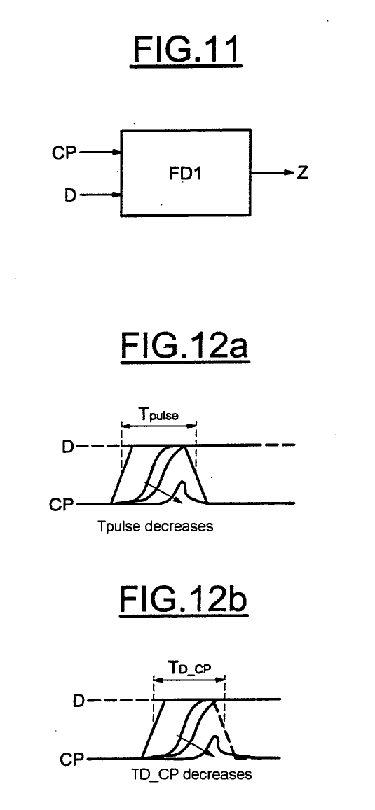

The invention is not limited to characterizing logic cells, such as logic gates, but also to characterizing sequential cells such as, for example, sequential flip-flop gates. An example of such a sequential cell FD1 is illustrated in FIG. 11. It comprises a clock input for receiving a clock signal CP, a data input for receiving data D and an output Z.

In the sequential cells, a data item enters into the gate for a certain logical level of the clock (high or low depending on the cell) and appears at the output only after the clock has switched. Two categories of constraints, illustrated in FIGS. 12a and 12b, appear in these sequential gates. The first constraint concerns only one signal, for example the clock signal (FIG. 12a), and the second is the time interval to be respected between two signals, in this case the clock and the data (FIG. 12b).

In the case of a flip-flop type circuit, such as the flip-flop circuit FD1, the data enters into the gate at the logic zero level of the clock and appears at the output when the latter rises to the 1 level. The pulse width Tₚᵤₗₛₑ of the clock must be sufficient to enable the data to be stabilized in the cell before being stored and/or copied to the output. If the pulse width is not sufficient, the sequential gate does not trigger correctly and the data is lost as is also shown in FIG. 12a.

Similarly, FIG. 12b shows that the data needs to retain its value for a minimum time interval TD-CP when the clock falls. If this constraint is not observed, an error may occur when processing the data.

The history effects on these constraints have complex consequences because they act differently on the two edges of the clock and on the two edges of the data and the clock. Furthermore, the number of initial conditions is increased to 2^{n+P} with n being the number of inputs and p the number of data items stored in the cell. However, implementing the method according to the invention is very simple, particularly for the pulse width.

In practice, slowing down the propagation of the rising edge also accelerates the falling edge. By acting thus, the pulse 0-1-0 of the clock is contracted within the gate. To maintain the functionality of the sequential cell, the pulse width must then be increased. Slowing down the rising edge of the clock in the cell FD1 can therefore be used to directly characterize the worst case of the pulse width constraint.

Similarly, the competition between the clock and the data is resolved by slowing down the incoming edge first and by speeding up the rate of the second. The appropriate MIN/MAX combinations for the transistors of this cell will then be chosen according to predefined rules concerning the slowing down and/or acceleration of the various edges.

The method according to the invention is ideally suited to the characterization of standard cell libraries. It can be used to find, in two simulations only, the worst and best propagation time cases for a given event. In most cells, the method also allows the characteristics of all the events to be grouped in a single simulation. Moreover, this characterization protocol is capable of limiting the dispersion of the propagation times associated with a random stimulus.

In practice, the combination of initial conditions constructed by internal potentials behaves like an asymptote for the overall charge state of the circuit. By refreshing certain potentials, a random stimulus can be used to converge towards this limit without ever exceeding it or, above all, reaching it.

All of the history effect, whatever the stimulus applied, is characterized with an accuracy and a number of simulations divided by a factor 2ⁿ⁻¹ compared to the prior art, including in cells with variable path and for the constraints of sequential cells. With an increase in the number of simulations less than a factor of 2 compared to gates on solid silicon, for which the constraints require only one simulation, the method according to the invention provides a response to the challenge of industrial characterization of libraries of standard cells in SOI-PD technology.

Physically, the simulation 11 running through the 2ⁿ initial conditions typically uses a transistor model of the “partially depleted BSIM3SOI” type available on the Berkeley University (US) website, or even a “SOISPICE” type model available from the University of Florida (US). The same applies for the calculation by simulation of the internal potentials in the phase for creating the database DB.

Moreover, these functional simulations and that relating to the characterization 5 can be performed by software simulation means MSIM (FIG. 2) typically using a simulation software known by the name ELDO and marketed by MENTOR GRAPHICS. The means MT for determining internal potentials (FIG. 2) can also be produced by a specific software module implemented in the simulator MSIM.

1-28. (canceled)

29. A method of characterizing a cell to be implemented in a partially depleted silicon-on-insulator CMOS technology and including a number of MOS transistors, the method comprising:
executing a preliminary phase, independent of characteristics of the cell, in which a database is created, containing at least one reference transistor having reference characteristics;
obtaining different internal potential values of a floating substrate of the at least one reference transistor for reference biasing of electrodes of the reference transistor initially biased to different initial bias values;
executing a simulation in which real bias values of the electrodes of each transistor of the cell are determined for possible steady states of the cell;
determining internal potential in which, for each transistor of the cell, a minimum value and a maximum value of its internal potential are determined from different real bias values and the database;
executing an initialization phase in which the floating substrate of each transistor is initialized with a minimum or maximum value of its internal potential according to a set of rules, and all nodes of the cell are initialized to the reference bias; and
executing a characterization phase in which a characterization stimulus is applied to the initialized cell.

30. The method according to claim 29 wherein the preliminary phase is performed by simulation based on a model of the at least one reference transistor.

31. The method according to claim 29 wherein in the preliminary phase, the electrodes of the at least one reference transistor are initially biased with different initial bias values, then, for each set of initial biases, these initial bias values are restored in a set time to the reference bias.

32. The method according to claim 31 wherein the set time is less than a discharge time of the floating substrate of the transistor.

33. The method according to claim 29 wherein the database is created for different reference transistors having different reference characteristics.

34. The method according to claim 29 wherein the internal potential determination includes an interpolation in the database.

35. The method according to claim 29 wherein the set of rules includes when propagation of a rising input edge on a gate of a transistor of the cell should be accelerated or when propagation of a falling input edge on the gate of the transistor should be delayed, initialization of the floating substrate of the transistor with a corresponding maximum internal potential value, and when propagation of a rising input edge on the gate of the transistor of the cell should be delayed or when propagation of a falling input edge on the gate of the transistor should be accelerated, initialization of the floating substrate of the transistor with a corresponding minimum internal potential value.

36. The method according to claim 29 wherein the set of rules includes an initialization of the floating substrate of a transistor of the cell, a gate of which is subject to no signal edge, and which is linked by its source or its drain to another transistor of the cell, a gate of which is subject to a signal edge, to a corresponding minimum or maximum internal potential value depending on whether the floating substrate of the other transistor is initialized to its maximum or minimum value, respectively.

37. The method according to claim 29 wherein the cell comprises a logic cell.

38. The method according to claim 37 wherein the characterization phase includes a determination of a best case and a worst case of time propagation between an input signal of the cell and a corresponding output signal.

39. The method according to claim 38 wherein the set of rules includes, for the determination of the best propagation case, an initialization of the floating substrate of each transistor of the cell, a gate of which is subject to a rising edge, to a corresponding maximum internal potential value, and an initialization of the floating substrate of each transistor of the cell, the gate of which is subject to a falling edge, to a corresponding minimum internal potential value.

40. The method according to claim 38 wherein the set of rules includes, for a determination of the worst propagation case, an initialization of the floating substrate of each transistor of the cell, a gate of which is subject to a rising edge, to a corresponding minimum internal potential value, and an initialization of the floating substrate of each transistor of the cell, the gate of which is subject to a falling edge, to a corresponding maximum internal potential value.

41. The method according to claim 29 wherein the cell comprises a sequential cell.

42. The method according to claim 41 wherein the sequential cell includes an input for a clock signal and an input for a data signal, and in that the characterization phase includes a limiting of a time difference between the clock signal and the data signal.

43. A system for characterizing a cell to be implemented in a partially depleted silicon-on-insulator CMOS technology and including a number of MOS transistors, the system comprising:
a database containing, for at least one reference transistor having reference characteristics, different internal potential values of a floating substrate of the at least one reference transistor obtained for a reference biasing of electrodes of the at least one reference transistor initially biased to different initial bias values;
a simulation unit to determine, for possible steady states of the cell, real bias values of the electrodes of each transistor of the cell;
an internal potential determiner to determine, for each transistor of the cell, a minimum value and a maximum value of its internal potential based on different real bias values and said database; and
an initialization unit to
initialize the floating substrate of each transistor with the minimum or maximum value of its internal potential according to a set of rules,
initialize all nodes of the cell to the reference bias, and
apply a characterization stimulus to the initialized cell.

44. The system according to claim 43 further comprising an auxiliary unit to create said database by simulation based on a model of the at least one reference transistor.

45. The system according to claim 43 wherein the auxiliary unit initially biases the electrodes of the at least one reference transistor with different initial bias values, then, for each set of initial biases, restores these initial bias values in a set time to the reference bias.

46. The system according to claim 45 wherein the set time is less than a discharge time of the floating substrate of the at least one transistor.

47. The system according to claim 43 wherein said database is created for different reference transistors having different reference characteristics.

48. The system according to claim 43 wherein the internal potential determiner includes an interpolator to perform an interpolation in said database.

49. The system according to claim 43 wherein the set of rules includes, when propagation of a rising input edge on a gate of a transistor of the cell should be accelerated or when propagation of a falling input edge on the gate of the transistor should be delayed, initialization of the floating substrate of the transistor with a corresponding maximum internal potential value, and when propagation of a rising input edge on the gate of the transistor of the cell should be delayed or when propagation of a falling input edge on the gate of the transistor should be accelerated, initialization of the floating substrate of the transistor with a corresponding minimum internal potential value.

50. The system according to claim 43 wherein the set of rules includes initialization of the floating substrate of a transistor of the cell, a gate of which is subject to no signal edge, and which is linked by its source or its drain to another transistor of the cell, a gate of which is subject to a signal edge, to a corresponding maximum or minimum internal potential value depending on whether the floating substrate of the other transistor is initialized to its maximum or minimum value, respectively.

51. The system according to claim 43 wherein the cell comprises a logic cell.

52. The system according to claim 51 wherein the initialization unit determines a best case and a worst case of time propagation between an input signal of the cell and a corresponding output signal.

53. The system according to claim 52 wherein the set of rules includes, for determination of the best propagation case, initialization of the floating substrate of each transistor of the cell, a gate of which is subject to a rising edge, to a corresponding maximum internal potential value, and initialization of the floating substrate of each transistor of the cell, the gate of which is subject to a falling edge, to a corresponding minimum internal potential value.

54. The system according to claim 52 wherein the set of rules includes, for determination of the worst propagation case, initialization of the floating substrate of each transistor of the cell a gate of which is subject to a rising edge, to a corresponding minimum internal potential value, and initialization of the floating substrate of each transistor of the cell the gate of which is subject to a falling edge, to a corresponding maximum internal potential value.

55. The system according to claim 43 wherein the cell comprises a sequential cell.

56. The system according to claim 55 wherein the sequential cell includes an input for a clock signal and an input for a data signal, and in that the initialization unit is limits a time difference between the clock signal and the data signal.

57. A system for characterizing a cell to be implemented in a partially depleted silicon-on-insulator CMOS technology and including a number of MOS transistors, the system comprising:
a database containing different internal potential values of a floating substrate of at least one reference transistor obtained for a reference biasing of electrodes of the at least one reference transistor initially biased to different initial bias values;
a simulation unit to determine real bias values of the electrodes of each transistor of the cell;
an internal potential determiner to determine, for each transistor of the cell, a minimum value and a maximum value of its internal potential based on different real bias values and said database;
an initialization unit to
initialize the floating substrate of each transistor with the minimum or maximum value of its internal potential according to a set of rules,
initialize all nodes of the cell to the reference bias, and
apply a characterization stimulus to the initialized cell; and
an auxiliary unit to create said database by simulation based on a model of the at least one reference transistor.

58. The system according to claim 57 wherein the auxiliary unit initially biases the electrodes of the at least one reference transistor with different initial bias values, then, for each set of initial biases, restores these initial bias values in a set time to the reference bias.

59. The system according to claim 59 wherein the set time is less than a discharge time of the floating substrate of the at least one transistor.

60. The system according to claim 57 wherein the internal potential determiner includes interpolator for performing an interpolation in said database.
